(19) United States
(12) Patent Application Publication
(10) Pub. No.: US 2009/0327772 A1
(43) Pub. Date: Dec. 31, 2009

(54) POWER MANAGEMENT SYSTEM OF TERMINAL

(75) Inventors: Joo-Hyeong Lee, Seoul (KR); Seong-Hun Kim, Seoul (KR)

Correspondence Address: MCDERMOTT WILL & EMERY LLP, 600 13TH STREET, N.W., WASHINGTON, DC, 20005-3096, US

(73) Assignee: SDC MICRO INC.

(21) Appl. No.: 12/492,745

(22) Filed: Jun. 26, 2009

(30) Foreign Application Priority Data
Jun. 26, 2008 (KR) 10-2008-0061217

(51) Int. Cl. G06F 1/26

(52) U.S. Cl. 713/300

(57) ABSTRACT

A power management system optimizing the power consumption management of a terminal that uses limited power is disclosed. In more detail, a power management system of a terminal, which defines levels of power to be supplied in accordance with the operation state of the system or an application that is a currently activated application program and controls the amount of power supplied to software modules and hardware modules of the terminal by the defined levels of power, so that power management can be simply and easily performed and that the power supply amount is optimized to increase a power supply time.

### BACKGROUND OF THE INVENTION

1. Field of the Invention

The present invention relates to a power management system for optimizing the power consumption management of a terminal that uses limited power, and more particularly to, a power management system of a terminal, which defines levels of power to be supplied in accordance with the operation state of the system or an application that is a currently activated application program and controls the amount of power supplied to software modules and hardware modules of the terminal by the defined levels of power, so that power management can be simply and easily performed and that the power supply amount is optimized to increase a power supply period.

2. Description of the Related Art

In general, since a communication terminal such as a computer, a portable terminal, a personal digital assistant (PDA), and a plasma display panel (PDP) uses a limited power supply, the most important thing is whether electric power can be continuously supplied to the terminal for a certain time period without additionally connecting a power supply.

For example, the computer terminal employs a current power save function, which will be schematically described. In accordance with the operation state of the computer, power to be supplied is reduced by step to minimize power consumption caused by the computer. The operation modes of the computer having the current power save function are classified into a normal operation mode, a standby mode, a suspend mode, and a soft off mode. The power to be supplied is reduced by step in accordance with the operation modes. A power management system for controlling the power to be supplied in accordance with the operation modes is provided in the computer.

However, a power management system of a terminal in accordance with various states such as the software modules, the hardware module, and the state of the application that is the currently activated application program is not currently proposed.

### BRIEF SUMMARY OF THE INVENTION

The present invention has been made in view of the above problems, and the present invention provides the power management system of a terminal, which defines levels of power to be supplied in accordance with the operation state of the system or an application that is a currently activated application program and controls the amount of power supplied to software modules and hardware modules of the terminal by the defined levels of power, so that power management can be simply and easily performed and that the power supply amount is optimized to increase a power supply period.

In order to achieve the above mentioned aspect of the present invention, the present invention provides a power management system of a terminal, including: a system sensing unit sensing a system operation state of a terminal such as a booting mode, an ON mode, an idle mode, and a suspend mode, an application sensing unit sensing an operation state of a currently activated application program, a software module executing the application program, a hardware module executing the system operation state and the application program of the terminal, a power supply supplying electric power to the software module and the hardware module, and a power manager receiving result data of the system sensing unit and the application sensing unit and controlling the amount of the electric power to be supplied to the software module and the hardware module by a level of supplied electric power set in accordance with the operation state.

The level of the electric power is defined to a PL4 level as a state where the software module and the hardware module have maximum performances, a PL3 level as a state where the software module and the hardware module operate but do not require the maximum performances, a PL2 level as a state where the software module and the hardware module are partially used only when the software module and the hardware module are required to operate, a PL1 level as a state where the software module and the hardware module are in a standby state so that only standby power is used, and a PL0 level as a state where the software module and the hardware module are not used so that no power is used.

According to the present invention, the power management system of a terminal defines levels of power to be supplied in accordance with the operation state of the system or an application that is a currently activated application program and controls the amount of power to be supplied to software modules and hardware modules of the terminal by the defined levels of power so that power management can be simply and easily performed and that the power supply amount is optimized to increase a power supply period.

That is, the terminal that uses the limited power such as a battery can effectively manage power consumption so that the use time of the battery can be prolonged and that the complicated and long-taken power management function of the terminal can be easily developed.

### BRIEF DESCRIPTION OF THE DRAWINGS

The objects, features and advantages of the present invention will be more apparent from the following detailed description in conjunction with the accompanying drawings, in which:

FIG. 1 is a schematic block diagram of a power management system according to an embodiment of the present invention.

### DETAILED DESCRIPTION OF THE INVENTION

Hereinafter, a power management system according to embodiments of the present invention will be described in detail with reference to the accompanying drawings.

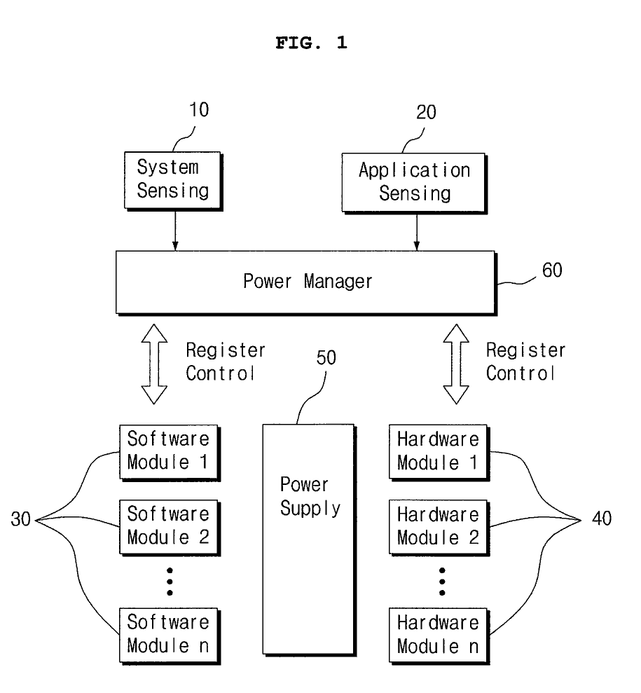

FIG. 1 is a schematic block diagram of a power management system according to an embodiment of the present invention.

Referring to the drawing, a power management system according to an embodiment of the present invention includes a system sensing unit 10 sensing a system operation state such as a booting mode, an ON mode, an idle mode, and a suspend mode of a terminal, an application sensing unit 20 sensing the operation state of a currently activated application program, software modules 30 executing the application program, hardware modules 40 executing the system operation state and application program of the terminal, a power supply 50 supplying electric power to the software modules 30 and the hardware modules 40, and a power manager 60 receiving result data of the system sensing unit 10 and the application sensing unit 20 and supplying the amount of power controlled by the software modules 30 and the hardware modules 40 in a power supply step set in accordance with the operation state.

Here, the system sensing unit 10 is provided to sense the current operation state of the terminal, for example, the booting mode, the ON mode (normal operation mode), the idle mode, the suspend mode, and a multimedia mode.

Here, the booting mode means a step of applying the power of the system to initialize the system. The ON mode means a normal operation step of initializing the system to be used. The idle mode means a standby step in which the system does not operate in a system on state. The suspend mode means a step of minimizing the power of the system so that the system enters into a standby state. The multimedia mode means a step in which the system performs a multimedia function.

The system sensing unit 10 senses to which mode the operation state of the current terminal corresponds among the plurality of above-described modes and transmits result data to the power manager 60 to be mentioned later.

The operation state can be particularly or inclusively defined in accordance with setting up other than the above-described various operation states. In accordance with the defined operation state, the system sensing unit 10 generates and transmits sense result data.

In addition, the application sensing unit 20 senses which application program is currently activated in the terminal and transmits the sensed result to the power manager 60. The activated application program can be classified into various categories to be defined in accordance with the power consumption.

On the other hand, the software modules 30 refer to software blocks required for executing the application program such as CODEC. The various software modules have power level registers. When the power manager 60 changes the registers into required level values, the software modules 30 adjusts power levels to corresponding levels.

The hardware modules 40 refer to hardware blocks, such as a monitor serving as a display, a keyboard, a central processing unit (CPU), and a mouse, provided to operate the system operation and to execute the activated application program. The hardware modules 40 have power level registers like the software modules 30. When the power manager 60 changes the registers into required level values, the hardware modules 40 adjusts power levels to corresponding levels.

The power supply 50 is provided to supply electric power to the software modules 30 and the hardware modules 40. The power supply 50 supplies the amount of power set in accordance with the power levels of the corresponding modules.

The power level registers mean levels of power to be supplied and may be defined by the examples illustrated in Table 1 in accordance with setting up.

TABLE 1

| | |
|---|---|
| PL4 | State where modules have maximum performances. Maximum |
| | power is used. |
| PL3 | State where modules operate but do not require maximum |
| | performances. Smaller amount of power than PL4 is used. |
| PL2 | State where modules are partially used when operations are |
| | demanded. Power is effectively used since most modules |
| | are in a standby state. |
| PL1 | State where modules are in a standby state. Only standby power |
| | is used. |
| PL0 | State where modules are not used. No power is used. |

On the other hand, the power manager 60 receives the result data of the system sensing unit 10 and the application sensing unit 20 to change the power level values set in accordance with the operation states. Therefore, the corresponding modules are supplied with power proper to the changed power levels.

The power levels of the software modules 30 and the hardware modules 40 in accordance with the operation states of the system sensing unit 10 and the application sensing unit 20 may be defined by the examples illustrated in Table 2 in accordance with setting up.

TABLE 2

| State | Necessary module and power level |
|---|---|
| Booting | ALL module (PL4) |
| ON | ALL module (PL4) |
| Idle | LCD (PL2), Keyboard (PL2), CPU (PL3), Others (PL1) |
| Multimedia | LCD (PL3), Codec (PL3), CPU (PL3), Others (PL2) |
| SUSPEND | CPU (PL1), Keyboard (PL1), Others (PL0) |

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A power management system of a terminal, comprising:
a system sensing unit sensing a system operation state of a terminal such as a booting mode, an ON mode, an idle mode, and a suspend mode;
an application sensing unit sensing an operation state of a currently activated application program;
a software module executing the application program;
a hardware module executing the system operation state and the application program of the terminal;
a power supply supplying electric power to the software module and the hardware module; and
a power manager receiving result data of the system sensing unit and the application sensing unit and controlling the amount of the electric power to be supplied to the software module and the hardware module by a level of supplied electric power set in accordance with the operation state.

2. The power management system of claim 1, wherein the level of the electric power is defined to:
a PL4 level as a state where the software module and the hardware module have maximum performances;
a PL3 level as a state where the software module and the hardware module operate but do not require the maximum performances;
a PL2 level as a state where the software module and the hardware module are partially used only when the software module and the hardware module are required to operate;
a PL1 level as a state where the software module and the hardware module are in a standby state so that only standby power is used; and
a PL0 level as a state where the software module and the hardware module are not used so that no power is used.
